(19) United States
(12) Patent Application Publication
(10) Pub. No.: US 2016/0063658 A1
(43) Pub. Date: Mar. 3, 2016

(54) Computer Confirmation of Emergent and Non-Emergent Transportation Services

(71) Applicant: Earl Edward Breazeale, JR., Louisville, TN (US)

(72) Inventor: Earl Edward Breazeale, JR., Louisville, TN (US)

(21) Appl. No.: 14/838,342

(22) Filed: Aug. 27, 2015

Related U.S. Application Data
(60) Provisional application No. 62/042,640, filed on Aug. 27, 2014.

(51) Int. Cl. G06Q 50/30; G06Q 50/22; H04W 4/02

(52) U.S. Cl. CPC G06Q 50/30; H04W 4/021; G06Q 50/22

(57) ABSTRACT

A computer-implemented method includes receiving at a location verification system a pre-authorization for transportation services that includes a transaction identifier and data identifying (a) locations at which medical transportation services are to be provided for a patient, and (b) a transportation service provider to perform the services; monitoring location reports from one or more vehicles determined to be operated by the transportation service provider to obtain location information that describes where the one or more vehicles have been located; comparing the data generated from the location reports to the locations at which medical transportation services are to be provided for the patient; determining, from the comparison, whether pre-authorized transportation services were provided for the patient; and providing electronic data for an organization of a third party payer that indicates to the third party payer whether the pre-authorized transportation services were provided.

### CROSS-REFERENCE TO RELATED MATTERS

This application claims priority to U.S. Provisional Application Ser. No. 62/042,640, filed on Aug. 27, 2015, the entire contents of which are hereby incorporated by reference.

### TECHNICAL FIELD

This document relates to systems and techniques for improving the operation of computing systems that process electronic claims submitted by medical service providers such as ambulance service organizations and other transportation service providers.

### BACKGROUND

Processing of electronics claims relating to the provision of medical services is an expensive, and often error-filled and fraud-filled, process. Sometimes the errors or fraud involve claims that overstate the level of care that was provided, such as a home healthcare provider indicating more home visits or longer home visits than actually occurred. Other times, the claims indicate care that never occurred, such as a provider not showing up for a home visit or not providing needed transportation from a patient's residence to a treatment center, a hospital claiming for a procedure that never occurred, or an ambulance service claiming for a call that was never made. Together, these sorts of errors and frauds lead to many billions in unnecessary waste for the federal and state governments and for individuals who are required to pay taxes and health insurance premiums.

In the area of transportation services, operators of ambulances and other transportation services may make claims for services they provide, either in emergent situations or in non-emergent situations, such as where emergency medical technicians (EMTs) or others provide pre-arranged home care services—e.g., driving particular homebound patients to pre-scheduled appointments repeatedly over the course of multiple weeks.

### SUMMARY

This document describes systems and techniques by which electronic claims for the provision of healthcare services, and in particular, in the form of ambulance calls and other transportation services, can be made more reliable and accurate, and less fraud-prone. The systems and techniques described here improve the operation of computer systems tasked with implementing such processes, by making those systems more secure, and also fundamentally changing how the computer-based processing occurs so as to bring greater surety and convenience to the processing. In certain implementations, different server systems and tangible transponders are provided in unique and specialized arrangements so as to permit a first entity to capture location (and perhaps time) information about vehicles, to transmit it reliably (without fear that it is being faked) to another party that verifies whether transportation services were provided (using the received location information and other information, such as information given it by a payer or the provider of transportation services), and that then confirms with a payer whether transportation services that were supposed to be provided were in fact provided (so that the payer can determine whether to pay or reject a claim from the transportation provider).

In the techniques discussed here, a computer system may be provided to generate a transaction identifier that represents a particular ambulance call or group of calls, and where the identifier is used within particular server systems and organizations to find information, and passed between different servers systems and organizations to coordinate action, such as a location verification system informing a payer system about the services it is saying were provided or were not provided (e.g., an ambulance of type Z drive from point X to point Y on date A, all under transaction identified 834F5TGA). As other examples, an ambulance operator may submit the identifier to a payer along with a claim for payment, and the payer may use the identifier to query the computer system of a location verifier for information that describes the ambulance call, such as information that indicates the location of an ambulance call, the drop off for the call (e.g., a particular hospital emergency room), and the number of miles for the call to be awarded for the claim (where compensation for an ambulance call may be a combination of a one-time fixed fee plus a per-mile fee).

The transaction identifier may be generated by the payer or another party, such as the payer generating an identifier for a group of pre-authorized non-emergent trips (and perhaps other services) for a particular patient over a particular time period, such as 30 or 60 days. The identifier may then be used by the transportation service provider when it makes a claim for compensation and also by a third party location verification company, which may associate the identifier with a certain geographic area (the patient's residence) and may check for incidents in which a vehicle of the transportation service provider is in such a geographic area (e.g., by placing a geo-fence around the patient's residence and around various treatment centers, such as dialysis centers, physical therapy centers, and clinics). Such location tracking may be applied across a single vehicle or an entire fleet for a transportation service provider or a sub-fleet (e.g., all vehicles of a certain size or capability in the fleet, when such is required for a particular patient, such as all handicap-accessible minivans or all mini-buses or all ambulances (for especially serious patients)), so that the location tracking system can register that transportation services occurred even if a different ambulance picked the patient up from one day to the next.

When the payer receives the submission of the transaction identifier (e.g., in a claim for compensation from the transportation service provider), it may decode the identifier (if the identifier is encoded) and/or submit the identifier to the location verification system in order to obtain the information that characterizes the trip or trips made by the vehicle of the transportation service provider. Alternatively, the transportation service provider may take steps to have the location tracking service independently provide verification data to the payer. The payer may then determine, from verification information it receives from the verification system, that the claim is compliant (at least with respect to whether the relevant services were provided, and perhaps to the amount of the services, such as number of transportation trips and length of each trip where payment includes a per-mile component) and should be honored if the location information matches (e.g., the time and location information received from the location tracking computer system matches with other information about the trip—such as time information from a claim submitted by an ER to which the patient was taken and dropped off by the ambulance, or information in a pre-authorization order).

The identifier may be a unique alphanumeric string—where “unique” is understood in the context of needing an identifier that does not match other identifiers received around the same time, so that one set of transactions can be distinguished from all other sets of transactions currently in use by the system. For example, it may be possible to recycle the same identifier as long as it is not repeated during a relevant time period (e.g., a plurality of full billing cycles). The identifier may also be made up of multiple concatenated identifiers, such as a first identifier for a particular ambulance service company, and a unique identifier within all the identifiers assigned to that company.

The identifier may simply be a unique transaction ID or can be an encoding of actual information. As a simple transaction ID, the identifier can be used to look up additional information about a patient transaction in a database, e.g., the ID number 194H4B can be applied to a look-up table or other form of database to get information about pick-up and drop-off locations and times for a particular transportation service provider for a particular patient. An encoded identifier may be processed to directly provide relevant data, without a need to go to a separate database. For example, as a representation that may encode information, such as pick-up or drop-off times and locations, the identifier may be provided to an algorithm that transforms it into the underlying data. In this manner, the identifier may act like a “PlusCode,” which in the past was used to encode start and end times for television program recording with enhanced video cassette recorders (VCRs). Such a code, such as a 10-digit alphanumeric code, may be provided to a decoding algorithm which may in turn produce start and end times (pick-up and drop-off times for an ambulance) and locations (e.g., lat/long coordinates).

To prevent fraud (e.g., an ambulance company generating an encoding to produce time and location data that it has faked), the code itself may be further encoded using a private key. This may allow the encoded data to be shared by a payer without fear that a third party will illicitly alter the data. For example, a payer could generate the encoded identifier by providing the underlying data to a function that encodes it and then encrypts it with a private key, may submit the encoded code to third parties such as the transportation service provider or a location verification service along with a credential that identifiers it as a legitimate submitter of the information, and the recipients could return the encoded or un-encoded version of the code, which the payer could then store (and perhaps un-encode using its private key) and, at the same time or later, apply the algorithm to in order to identify the time and location data in it.

The information that the claimant (e.g., the transportation service provider) provides when requesting the code may include a variety of information. As described below, such information may include an identifier for the particular transaction or patient (e.g., a personal Medicare or insurance number), documentation indicating that a qualified physician has identified a legitimate need for such services (and data identifying that physician), and other information that the payer may need in order to approve the transportation services in advance of them occurring, to make a successful payment, and to verify that the making of such a payment is properly warranted. The claimant may likewise present just the code and/or additional information when making a claim after having provided the relevant transportation services.

All or a portion of such information may be provided manually or automatically when a claim is made or at other times. For manual entry, an employee of an ambulance service may complete a paper or electronic form and fill in the relevant information for each field in the form (e.g., a claim form from the payer). The entry may also be semi-manual, in that certain entries may be provided pre-set in a drop-down or in another suggestion, and the user may select the suggestion or enter a different value. For example, all of the hospitals to which an ambulance service delivers patients can be listed in a drop down menu for the particular ambulance service, and the user may quickly select the hospital to which her ambulance took a patient. But when the drop-off is out of area (e.g., to a helipad for air transport of a patient), then the user can enter the information manually.

Other data can be provided automatically. For example, time and location data may be collected automatically by a computing device in or associated with the ambulance and may be populated into unchangeable areas of a form, or simply transmitted to the computer system automatically (e.g., via GPS information being transmitted). Also, other identifiers may be entered, and detailed information may be obtained automatically using relational database techniques, such as by the provision of a patient number (e.g., SSN), physician number, transportation service provider number and the like, where contact information, names, and other such extra data may be obtained automatically upon receiving the relevant number.

Location data for vehicles of a transportation provider (and/or for mobile devices carried by drivers or occupants of such vehicles) data may be gathered and/or transmitted periodically (e.g., by a third party location verification system), upon the occurrence of an event (e.g., the ambulance stopping motion for a period of time and/or being shifted into park, to indicate that it is able to pick up or drop off a patient), or upon a request from a user to transfer data (e.g., the driver or passenger performing a check in or check out at an endpoint location). For example, a mobile device may be provided in an ambulance or other vehicle and may be executing, among other applications, an application associated with a computer system of the location verification system that causes location information generated by a GPS unit in the device to be transmitted to the computer system when an operator (the ambulance driver, e.g.) selects a relevant icon on the device screen when she is in the application (e.g., to indicate a check in or check out). In other instances, a user may select an icon to obtain a unique identifier from the computer system that represents a particular trip or group of trips, and such selection may then cause the computer system to query a device associated with the user to send data that the device has collected (e.g., time and location data for the prior n minutes, where n is a positive integer, and where the user's device may send such time and location information along with the unique identified to a location verification system).

The location verification computer system may then store the acquired location data from multiple vehicles programmed to report lat/long (and possibly time) information to the location verification system, along with the identifier and may wait for subsequent requests relating to such information. Such later requests may be made by payers (e.g., the government for medical claims, or private insurance companies) who have had the identifier submitted to them by the service provider as part of a claim (e.g., an ambulance company). In such a situation, the verification computer system may first determine that the requester is properly authenticated—e.g., the requesting user has provided sufficient credentials (user ID and password) to associate themselves with a legitimate organization, and the organization is signed up with the operator of the location verification computer system as a trusted organization, and perhaps also has been previously associated with the particular ambulance company, with the patient identified as being moved by the ambulance company, or otherwise (e.g., by being named on a pre-authorization submission that has been approved by a payer). Such associations may have been made initially through a pre-authorization for services that was made by the payer and where the transaction identifier was originally generated.

Upon the payer or other entity submitting the identifier, the location verification computer system may perform a look up using the identifier as a key, and may return all or some of the associated data (e.g., time and location data) that was previously received from the ambulance company or other service provider. Where pre-authorization was obtained and the location verification system has obtained information about what care (e.g., when, how much, and at what rates) the payer authorized, the location verification system can pass data sufficient to inform the payer of the portion of the project that has been successfully completed so that the payer may pay for such portion. Such reporting by the verification system may happen automatically as soon as it determines that a relevant round trip under a pre-authorization has been made—e.g., a vehicle of a proper type from the relevant transportation service provider has appeared inside a geo-fence for the patient's residence at a relevant time, has then appeared inside a geo-fence for a treatment center for the patient at an appropriate time, and has then appeared in a geo-fence for the residence again. Such set of determinations by the verification system may represent a payable transaction, so that the system may be programmed to automatically report the occurrence of such a transaction to a payer, or may transmit it when a request like that above (e.g., from the service provider submitting a claim) is made.

In one implementation, a computer-implemented method performed by a location verification computer system includes receiving at the location verification computer system a pre-authorization for transportation services that includes a transaction identifier and data identifying (a) locations at which medical transportation services are to be provided for a patient, and (b) a transportation service provider to perform the services; monitoring location reports from one or more vehicles determined to be operated by the transportation service provider to obtain location information that describes where the one or more vehicles have been located; comparing the data generated from the location reports to the locations at which medical transportation services are to be provided for the patient; determining, from the comparison, whether pre-authorized transportation services were provided for the patient; and providing electronic data for an organization of a third party payer that indicates to the third party payer whether the pre-authorized transportation services were provided. Such actions may also be performed by the execution, on one or more computer processors, of instructions stored on one or more tangible, machine readable storage media.

In certain implementation, such techniques may provide one or more advantages. For example, such techniques can improve the operation of computer systems that operate to verify claims that are made by third parties. Such improvements may help eliminate the need for manual follow-up and lower the number of audits that may be required. Also, such confirmation may generally require little storage or transfer of data, so that computer may be used with greater efficiency. Moreover, the modular nature of such a system for certain implementations—using a third-party computer system to perform the electronic verification actions for transportation services—may allow for easier implementation of such a system, in that legacy computer implementations may be made with minimal updates, and with minimal need of a payer to change its system to work with a large number of service providers. For example, basic APIs may be implemented, and the third party system may do the bulk of the work while interfacing readily with legacy payment and scheduling systems.

The details of one or more embodiments are set forth in the accompanying drawings and the description below. Other features and advantages will be apparent from the description and drawings, and from the claims.

### DESCRIPTION OF DRAWINGS

FIGS. 1A and 1B are conceptual diagrams of claim verification systems and processes.

FIG. 2 shows example fields for submission by a service provider.

FIG. 3 is a flow chart of a process for processing claims by providers.

FIG. 4 is a swim lane diagram showing operations performed by different components in a transportation system.

FIG. 5 shows an example computer system.

Like reference symbols in the various drawings indicate like elements.

### DETAILED DESCRIPTION

This document discusses techniques for computer processing of claims relating to provided healthcare, such as claims made to Medicare or private insurance providers. The techniques discussed here are directed to improving the performance of technical computer systems and the manner in which they collect technical data and interact with each other so as to provide heightened computer security and quality of processing.

In general, and as described in more detail below, a transportation service provider, such as an operator of an ambulance service or other emergent or non-emergent transportation service, may employ one or more devices that track information about its activity, such as time and location data (e.g., derived from a GPS component of a mobile device carried in an ambulance or carried by a person operating the ambulance). The transportation service provider may receive from a payer prior authorization to perform transportation services, such as to pick up a healthcare patient at a particular address (e.g., the patient's home), deliver them to another address (e.g., a hospital, clinic, dialysis center, etc.), return them to the original address, and perhaps perform other services (e.g., checking and continued monitoring of vital signs).

Such operations by the transportation service provider may be tracked in a variety of manners to confirm that the transportation activities actually occurred, and the extent to which they occurred (e.g., the number of miles driven so as to identify an amount to compensate the transportation service provider). For example, global positioning position transponders may be mounted in vehicles operated by a transportation service provider and may communicate via a wireless network with a location tracking server system, either continuously (whereby the server system will determine when they are at or near locations associated with authorized services) or on demand (whereby an operator of the vehicle may press a button or interact with a software application to indicate that a relevant pick-up or drop-off is occurring or about to occur). As described in various manners below, a third-party location verification service and system may perform such activity by receiving location reports from vehicles of providers who have signed up with the system and “aimed” their devices to report location to the verification system, and the third-party system may then respond to requests so as to provide a payer with secure and independent information that identifies whether particular services were provided, as a result of determining whether vehicles of the transportation service provider were at proper geographic locations at proper times. The data for the payer may be encrypted using a public key of the payer if the data is passed through channels that may compromise it (e.g., the verification system gives the data to the transportation service provider to have it forwarded to the payer) or can be sent directly to the payer so as to provide similar security (though it may still be encrypted, such as via SSL transactions and the like).

In some examples, such an operator of a transportation service may, upon performing a compensable operation or prior to performing such an operation, apply to a third party (e.g., an organization that performs location tracking verification) to obtain an identifier (e.g., an ID number) for activity that it has recently completed or will complete, or may receive such identifier without requesting it (e.g., by having such data “pushed” to its as part of a pre-authorization of services from a payer). The third party that provides location verification services may operate or subscribe to a computer system obtains the time and location data and perhaps other data submitted by the transportation service provider (e.g., via GPS-enabled devices in the provider's vehicles), and generates an transaction identifier for the particular unit of work or uses an identifier previously provided for the work (e.g., where the work was pre-authorized by a payer). The computer system may also transform or otherwise process the data, such as by identifying pick-up and drop-off points by an ambulance or other vehicle for a particular patient in a particular transaction (e.g., by determining that lat/long data received from mobile devices has entered geo-fences for residences of medical patients or for treatment facilities), and/or computing a distance traveled by the vehicle in providing the service, and perhaps a time expended by the vehicle. The third party verifier may give the identifier, in the form of an alphanumeric string, to the provider of transportation services, which may then pass it on with a request for compensation that it provides to a payer. Or the provider of services may obtain the identifier from a payer and may cause it to be provided to the operator of the verification services.

The payer that receives an identifier in a claim from a transportation service provider may then forward the identifier to the third party verifier, and may obtain back from the third party verifier the various data received by the third party verifier from the location-reporting devices of the transportation service provider and additional data (or derived data generated by the verifier, such as the verifier using lat/long and time information to determine that the provider actually performed services for a patient, with the verifier then sending the payer an indication that the particular services were performed, but not sending the payer the location data and other detail that the payer does not need), so that the payer can confirm that the service was performed, and may also confirm the level of service performed (e.g., the number of miles an ambulance or other vehicle traveled).

In other instances, the payer may provide the third party with information in addition to the transaction identifier, and the third party verifier may confirm whether the additional information is accurate. For example, the transportation service provider may have submitted a claim to an insurance company claiming to have performed certain work, such as claiming to have traveled X miles in an ambulance call. The payer can submit a corresponding identifier and the mileage, and the third party verifier can use the transaction identifier to look up the mileage it computed using its location data received from the ambulance, and may then respond affirmatively or negatively about whether there was a match. Separately, the transmission from the payer (which may also be from an agent of the payer in all examples described here, and will be considered in such circumstances to be by the payer) may identify the particular information the payer wants from the verifier—e.g., only confirmation that service on a particular date occurred or all services under a particular transaction identifier occurred, or additionally for some requests the total miles traveled between two geo-fence areas by the transportation service provider's vehicle, and perhaps a class of the vehicle (where larger or more complex vehicles have a higher compensation rate). The payer may change the type and level of detail that it requests from one request to another, though typically it will at least submit the unique transaction identifier so that the verification service can know which data to obtain for the payer.

The third party verifier can also automatically supply confirmation about service provided by the transportation service provider where it has previously been provided notice about pre-authorized services for a particular patient. For example, the payer (or a party working at the behest of the payer) may provide the third party verifier with information about a patient and a transportation service provider, including information that indicates a location for the patient's residence or other location where they are to be picked up and dropped off by the transportation service provider (in addition to other contextual information that can be provided). The third party verifier may then, via a dedicated server system, place a geo-fence around that location (e.g., for filtering location data received at a server system, or for an application on a client device at the vehicle, so that the application reports location data when it passes through the geo-fence, and perhaps continues to pass location data as long as its stays inside the geo-fence). The verifier may then log such data, and may immediately report the occurrence of a relevant event when the verification server determines that it has occurred (e.g., the completion of a round trip of transportation service from residence to treatment center back to residence), and/or may wait until a request is made by a separate organization such as the payer or the transportation service provider.

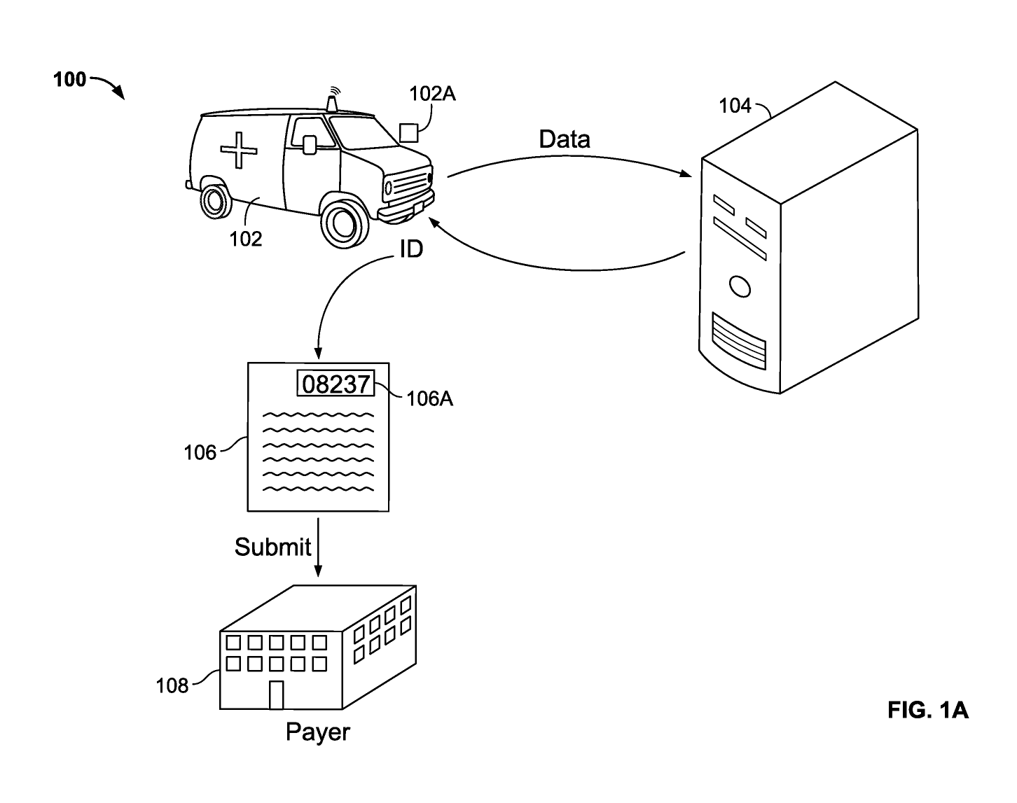

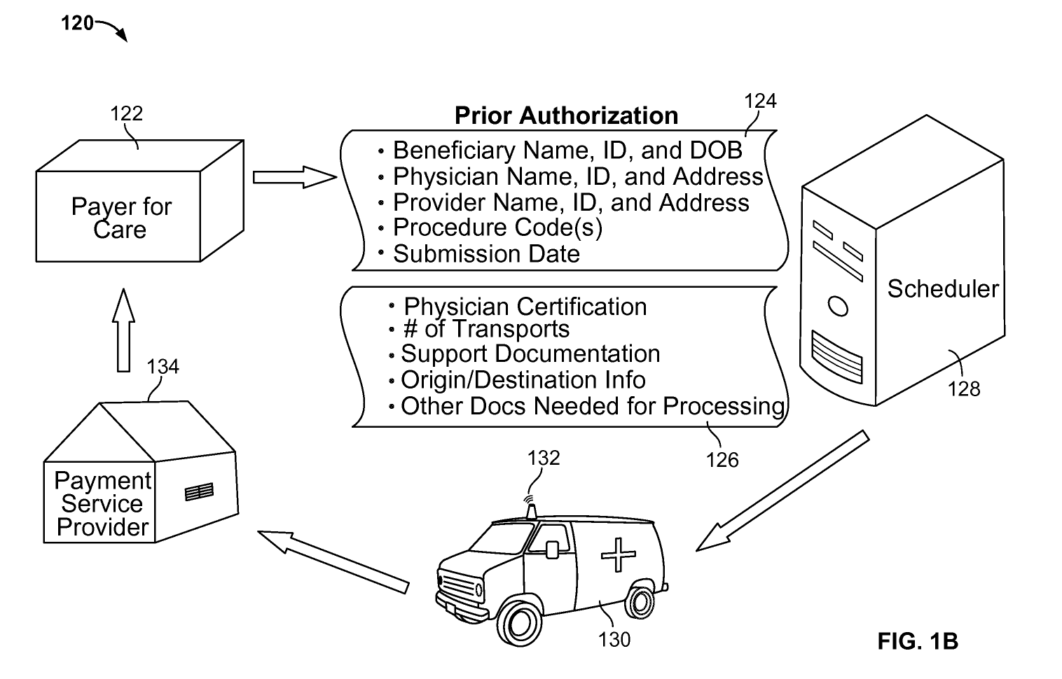

FIG. 1A is a conceptual diagram of a claim verification system 100 and process. In general, the system 100 shows a flow of steps that may be performed for a transportation service provider to have its claims for payment confirmed, via interaction with a location-tracking third-party 104. The process may occur by all the services being performed before they are specifically approved (e.g., for an emergent ambulance call, though the ambulance company may be previously generally qualified as an approved provider, though without approval for any specific future services). The process may also occur by the transportation provider providing some services before getting specific authorization and some after, or getting pre-authorization before providing any services (e.g., for non-emergent services with long lead time like long-term transportation such as transportation to dialysis treatment, where the transportation service provider may have a long-term relationship with the patient, and may be able to submit requests for pre-authorization for period such as 60 days well in advance of the start of those periods so that the payer has adequate time (e.g., a week of more) to check the request and provide the authorization.

The system 100 involves a transportation service provider represented by ambulance 102 and mobile device 102A, which may be a mobile smartphone operated by an EMT, a dash-mounted device in the ambulance 102, or other form of device that is capable of identifying a latitude and longitude of the ambulance 102 and to wirelessly report data for such locations at various times. While the ambulance makes a call, the device 102A may monitor the location of the ambulance and log time/location data for the ambulance 102 periodically or when requested by a user (e.g., the ambulance driver may press a button each time there is a relevant stop and the time/location data may be logged, or the logging may occur whenever the ambulance engine is shifted to park or turned off), or some other occurrence that can be mechanically and/or mechanically tracked and used to infer activity of the ambulance 102 without express input from the EMTs. Alternatively, the device 102A may report a large amount of undifferentiated time and location information to a remote server system which may then filter that data to identify data that matches locations and times for transportation services that have been authorized for the transportation service provider to perform.

When the call is over, the EMTs may be required to fill out paperwork, which may involve operating an application on device 102A. That action may result in the application requesting an identifier from third-party computer server system 104, to be used later as an identifier for the particular ambulance call, or other type of transaction that involves providing healthcare services and may result in a request for compensation later to a payer 108.

In this example, the system 104 generates an alphanumeric string to represent the transaction, where the string may simply be a sequential identifier that is unique from other identifiers or may be a string generated by applying certain time-location information received from the device 102A to a reversible algorithm. The system 104 may also store the identifier in a data base (shown graphically and representationally by a grid) and return the identifier to the device 102A or to another computer system associated with the service provider that operates the ambulance 102.

The identifier in some examples may have previously been generated by a payer or an agent of a payer, and then have been provided by the payer to the transportation service provider and/or the system. For example, when a patient is prescribed a particular type of care by a physician, the physician, a payer, or the patient, may provide information about the prescription to a transportation service company, which may then seek pre-authorization for performing transportation services for the patient. As one example, the patient may have been prescribed dialysis at a center 20 miles from their home. A payer may identify a transportation service company that is on a list of approved companies and which has a garage closest to the patient's home and also available transportation slots for days and times when the patient needs to be transported. The payer or other entity may notify the transportation service company, which may seek to obtain a contract or other approval to provide the service by making a submission of appropriate form, which the payer may then approve in order for the transportation service company to be paid for providing such services. As part of the process of communicating authorization to perform the services, the payer may provide the transportation service provider with an identifier that may subsequently be used as a tracking number for the transaction.

For example, as shown by form 106, the transportation service provider may later supply the identifier to the payer 108 in making a claim for payment for the provided services (e.g., as shown in the box 106A showing alphanumeric identifier 08237). The payer 108 may then supply the identifier to the location verification system 104—either alone or with other information. The location verification system 104 may respond by providing the payer 108 with information needed to confirm the legitimacy of the claim or may respond with an indication of whether the claim appears to be legitimate given the provided data. In other examples, the transportation service provider may provide the identifier to the location verification system 104, which may cause the location verification system 104 to forward verification information to the payer 108. In certain other situations, such as when pre-authorization has occurred, the location verification system 104 may be provided with parameters regarding the services to be provided and may automatically provide verification data to the payer 108 as soon as it recognizes that such services have been provided (e.g., when it sees that an ambulance for a particular service provide has entered and exited a geo-fence for a patient's home, for a cancer care center that provides chemotherapy, and again for the patient's home—perhaps also checking such actions to ensure that they match times when the patient was supposed to be transported).

FIG. 1B shows a computer-based system for tracking vehicle location and performance of transportation services similar to that in FIG. 1A, though in this example, the use of pre-authorization for those services is more explicit (though not necessary). Pre-authorization may be particularly appropriate for non-emergent service situations, such as for patients who need scheduled and repeated transportation services that are generally known in advance—e.g., for cancer or dialysis treatment. Payer authorization for such services may thus be more readily obtained before some or all of the services are provided. As a result, efficiencies for the operators and the computer systems may be obtained using the techniques discussed here because one round of processing may permit subsequent automatic processing of transportation transactions, and with the certainty that the information needed to make the transactions occur successfully is already in the system, and that rejections and re-processing need not occur.

In the figure, a payer for care 122 starts the example process. As shown, the payer for care 122 provides a prior authorization for transportation services to be provided. Such action by the payer for care 122 may have been triggered by a prior request for pre-authorization submitted by a particular transportation service provider, by a primary caregiver for the patient, or by the patient herself. As shown by documents 124 and 126, the pre-authorization may include a variety of information (and the prior request for pre-authorization may have included similar information or pointed to such information, such as pointing to details about a patient or transportation service provider by including an ID number for the patient and/or transportation service provider).

Document 124 shows basic fundamental data needed to carry out the services, including a beneficiary (patient) name, ID and date of birth; a physician name, ID, and address; a provider name, ID, and address; standardized procedure codes for the type of services that have been authorized (e.g., codes A0435, A0426, and A0428), and the date the authorization or request for authorization was submitted. The date may be relevant because the authorization may be valid only for a defined period, such as provision of services over 60 days after the date—such that services provided by the transportation service company after the closing date might not get paid, or at least the transportation service company could not force payment for such “late” services.

Document 126 shows additional information that may be communicated and that may be needed in order for the payer for care 122 to determine whether to approve a request for pre-authorization. Such information may include a certification from a qualified physician that such care (and associated transportation services) is needed; a listing of the number of transports that will be needed (e.g., 3 each week for 5 weeks); support documentation, such as a portion of the patient's medical record and other information; origin and destination information, such as lat/long coordinates for the patient's residence, the garage for the particular transportation service provided, and the treatment center location; and other documents that may be needed for processing.

The documents 124 and 126 or portions of the documents (which may be transmitted as structures or unstructured electronic data) may be initially provided to the payer for care 122 so that a representative (human or computer) may determine whether to grant the pre-authorization. Subsequently, the payer for care 122 may provide all or parts of the documents 124 and 126 to the transportation service provider and a location verification system, which may operate a scheduler system 128. The scheduler system 128 may use information from the documents 124 and 126 to identify times when transportation services will be provided to the patient, and also identify types of transportation resources (e.g., ambulances and crews, mini-vans, etc.) needed to provide the services, and particular resources that will be available at the relevant times to provide the services. The scheduler 128 may then send appropriate messages to the patient and service crew so that they will be coordinated with respect to timing of the services (e.g., so that the patient will be ready when the crew arrives and so that the patient will arrive at the treatment center when the treatment center is ready for the patient).

The location verification service (which may be part of a same server system as the schedule 128 and operated by a common organization, or may be part of a different server system) may subsequently receive location and time-location information from the transportation resources like ambulance 130 having a GPS unit 132 and wireless transmitter that is in communication with the location verification system, either directly or through a server system of the transportation service provider. Among other things, the unit 132 may transmit lat/long information either regularly or at the occurrence of an event, such as the entry and exit from a geo-fence being tracked using a device on the ambulance 130. The server system for the location verification system may include one or more interfaces arranged to receive (a) data from payers and others for setting up a transactions (such as documents 124 and 126), such as in the form of an EDI exchange, and (b) lat/long and other data from wireless mobile devices carried in vehicles of various transportation service providers. In certain options, the verification server system may also include the scheduler 128, and may include a comparison engine for identifying data from vehicle-carried mobile devices (e.g., lat/long and time data, though the time data may be generated by the server system at the time it receives certain lat/long data) that matches previously established parameters for transportation services that are to be provided, such as geo-fence data generated from a pre-authorization as described above and below. The verification server system may also be programmed to receive requests for verification of vehicle locations (e.g., from payers) and to respond with data that indicates to the requesters whether particular transportation services were provided.

At appropriate times, the location verification system may provide data generated from such received location information (from mobile devices in vehicles) to a payment service provider 134 or the payer for care 122. For example, when the transportation service provider makes a claim for payment for the services, it may submit the claim directly to the payer for care 122 or through the payment service provider 134. The payment server provider 134 may be an organization that is trusted by payers and that operates to help various medical care providers make claims to the government or to insurers, so that the claims take a proper format and are better able to be accepted and paid quickly. That submission may cause a notification to be provided to the location verification service that identifies the transaction, such as by the unique identifier discussed in more detail above and below. The location verification system may use the identifier to look up all of its data relating to that transaction to determine whether and when appropriate services were provided and also determine additional metadata about the services, such as the distances traveled (computed using the location information). The location verification service may then report such information to the payer for care 122 or the payment service provider 134, which may in turn bundle the verification information with other relevant information needed in a claim. The payer for care 122 may subsequently more easily determine that payment should be made, because it has received an objective measure, from the location verification service, that relevant services were likely provided (a relevant transportation resource was in the right areas at the right times).

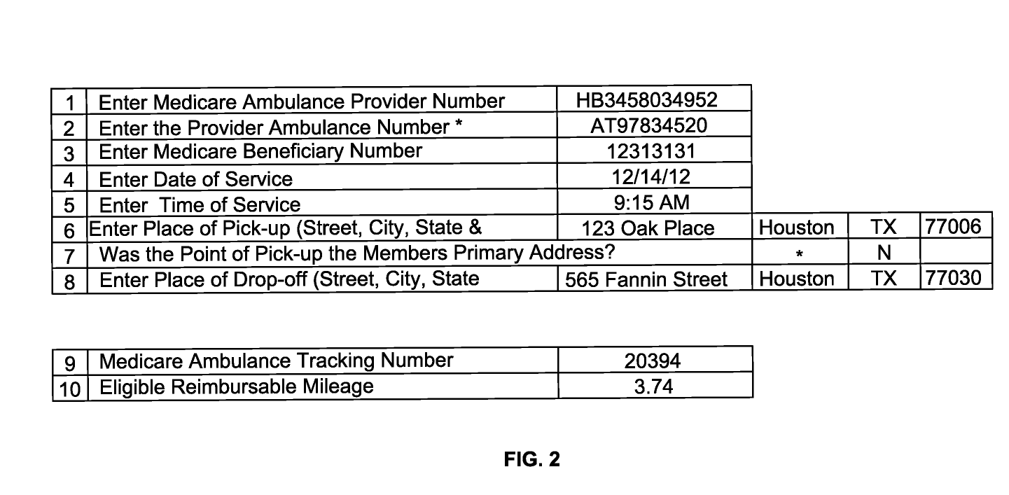

FIG. 2 shows example fields for submission by a transportation service provider. In general, such field may be tracked by a system like system 104 in FIG. 1 but may be populated and supplied by users at a service provider or devices used by the service provider (perhaps running one or more applications corresponding to the organization that operates the system 104). The first two fields identify the particular vehicle, and may be provided by a user when a device is set up for a company, and then automatically populated whenever a request is made for an identifier from the application on that vehicle. The third field is an identifier for the patient, which may be obtained when the ambulance arrives on site or after dropping the patient off at an ER, among other things. Where an actual policy number for a patient cannot be obtained, a temporary number can be generated, and the patient can be tracked by the ambulance system and the hospital system until a permanent number can be obtained (e.g., after a spouse of the victim arrives at the ER). The fourth and fifth fields are date and time of the event, such as a time when the ambulance was called or when it arrived at the place where the patient had a health problem. Multiple times may also be tracked (e.g., when the call was made, when the ambulance arrived at the patient, when the ambulance left the pick-up point, when the ambulance arrived at the ER, and when the ambulance left the ER). Such values may be populated automatically by the device at the ambulance after having been tracked by such a device. Manual overrides may be permitted, though the field may be flagged when such overrides occur so as to permit a user to fix problems but to dissuade the user from committing fraud because the user will know that any manual entries are more likely to be scrutinized. Similarly, the place of pick-up and drop off (in general) is shown and can also be provided manually or automatically. Field ten can also be provided at the ambulance or can be computed by the system 104.

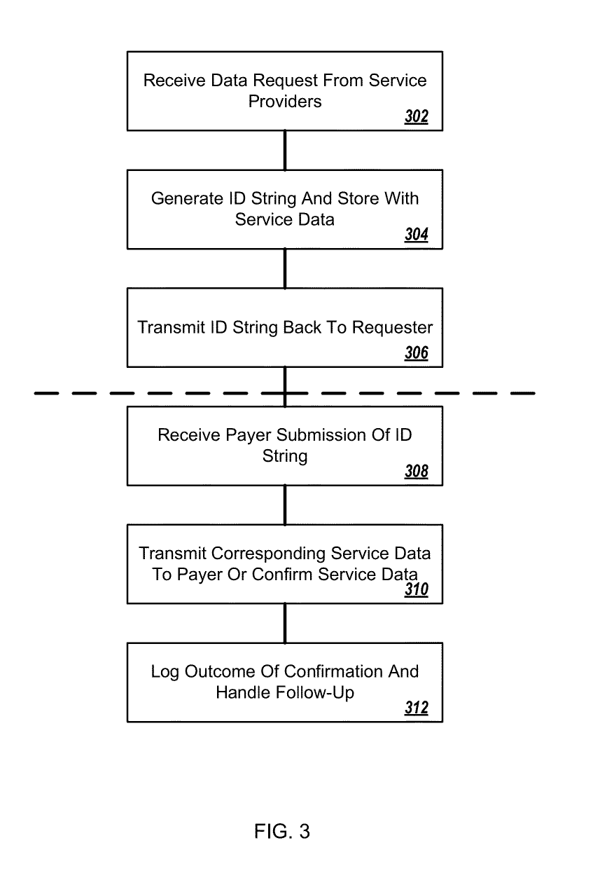

FIG. 3 is a flow chart of a process for processing claims by providers. The process is expressed here centered on a provider like system 104 in FIG. 1.

The process begins at box 302, where the system receives a data request from a service provider. Such request may include the service provider transmitting a block of data about a call for an ambulance, including time-location data like that discussed above. The request may also cause the system to directly request such data from a computing device on the ambulance.

At box 304, the system generates an ID string like that shown in FIG. 1A and stores it locally in association with data that characterizes the ambulance call, including the data for fields shown in FIG. 2. The ID string may be generated by any appropriate organization that is part of such a process, including a payer, a verification service, and a transportation service provider. The IS string is a unique identifier that the various systems can use as a key to identify the transaction or transactions that are being discussed. In a simplest form, each transaction when it is opened may be generated a sequential alphanumeric number. In more complex forms, different entities may have the ability to generate ID strings, and rules may be imposed to ensure that they do not generate overlapping or interfering strings. Also, as discussed above, the ID string can encode data, whereby a function can be applied to the ID string and may output relevant data such as ID numbers for patients and transportation service providers, lat/long coordinates for residences and treatment centers, and the like.

At box 306, the system transmits the ID string back to the requester, either directly to a device in the ambulance, or to a computer system at the headquarters of the organization that operates the ambulance. At box 308, a payer submits to the system an ID string, and the system checks all the ID strings it has previously created in order to identify whether there is a match. If there is a match, the system uses the ID as a look up to gather the additional stored data about the particular ambulance call, including time-location data. The system may then send some or all of such data back to the payer, or may test it against data that the payer submitted, such as time-location data or mileage the payer received from the provider with a claim for payment. At box 312, the system transmits such information (either confirmation or failure to confirm, or additional data) back to the payer. At box 312, the system logs the outcome of the request in its own database, and handles any follow-up. For example, the system may send other messages to the payer and service provider when a failure to confirm occurs, so that the two organizations can determine what problem occurred (where the problem could be innocent, fraudulent, or indeterminate). The system may also receive follow-up requests, as part of such an effort to determine what was wrong with the transaction, and may respond accordingly.

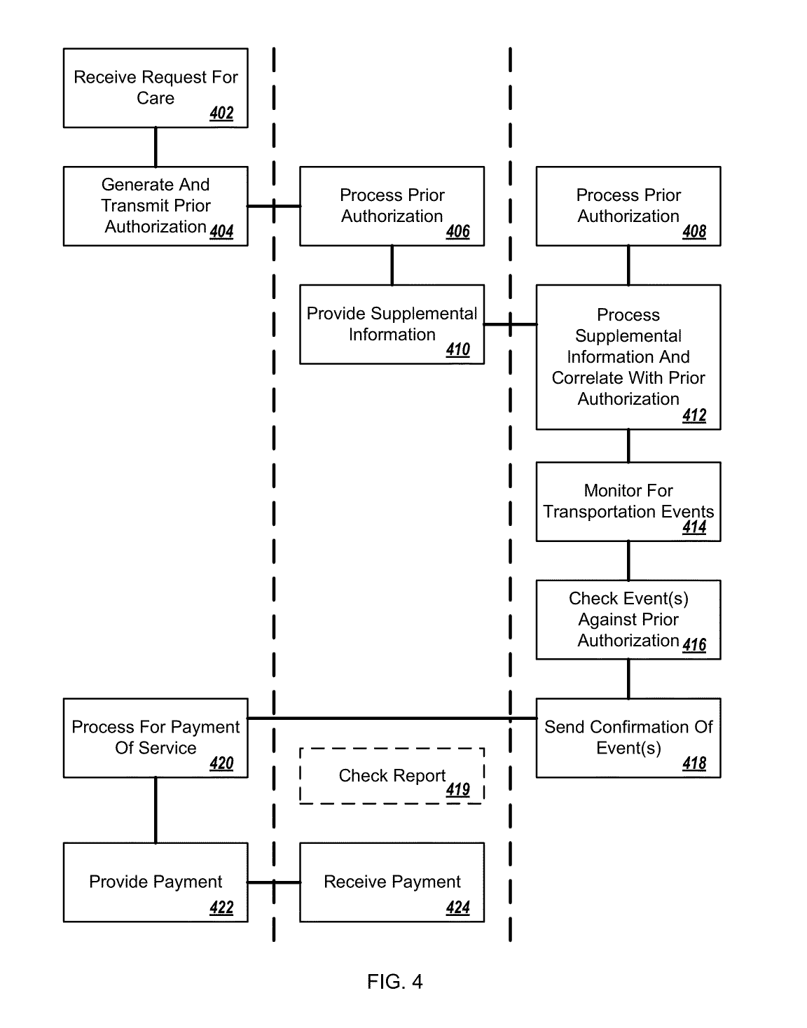

FIG. 4 is a swim-lane diagram of a process for processing claims relating to transportation services that have been pre-authorized. In general, the process involves a payer authorizing particular services, a transportation service provider performing the services, and a verifier tracking time and location information to confirm for the payer that the proper services actually occurred. The actions by the verifier may be in response to specific requests made after a claim is submitted, or automatically as soon as the verifier determined that relevant transportation resources carried out actions responsive to pre-authorized services.

The process begins at box 402, where the payer receives a request for care. The request may initially start with a physician who has prescribed care for a patient on a regular future basis at a site that is not at the patient's residence, such as chemotherapy or dialysis treatment. The request may be used to trigger a series of actions needed to ensure that the care is available for the patient when the patient is at the right location, that the patient can get to the location, and that the providers of services to the patient can obtain proper compensation for their services.

At box 404, the payer generates and transmits prior authorization for the services, including transportation services. Such an action may occur in response to an administrator at the payer confirming that a proper prescription or order from a qualified physician has occurred, that the care provider (e.g., dialysis center) is approved and a reasonable distance from the patient, and other such considerations to ensure that the care is proper and efficient. The payer or another party may have identified an appropriate transportation service provider, such as a pre-approved provider with a garage that requires the shortest travel distance and that has resources available at the appropriate times and dates. The payer may provide data from the prior authorization to the service provider and to the verifier.

At box 406 and box 408, the service provider and verifier, respectively, process the prior authorization. Such processing may involve parsing data from an electronic transfer that was part of the prior authorization, such as location data for the patient and the treatment center, and timing data for when trips are supposed to occur. The service provider may submit such information to an automatic scheduling system which may determine that a proper vehicle is available, may assign the vehicle to the transaction, and may add the transaction to a schedule for the vehicle that a driver of the vehicle may see when he or she arrives for a driving shift. The verifier may provide the data to a specialized tracking system that may generate geo-fences and subsequently trigger specific actions when data coming in from vehicles indicates that the vehicles have passed through relevant geo-fences.

At box 410, the service provider provides supplemental information to the verifier. For example, the service provider may provide a device ID for the GPS and communication device of the vehicle that has been assigned to perform the transportation services, so that the verifier may associate that ID with the particular geo-fences it has established for the care. Multiple device IDs may also be provided in appropriate circumstances, so that the service provider has flexibility in determining which vehicles to deploy to a particular patient's care.

At box 412, the verifier processes the supplemental information and correlates it (using the transaction identifier originally received from the payer) with the data received from the previously-generated prior authorization. For example, the verifier may correlate the device IDs with the geo-fences that it has previously generated.

At box 414, the verifier monitors for transportation events in the form of pick ups and drop offs of patients and relevant locations. Such monitoring may occur at various levels of automatic or manual operation and at the verifier's central server system or in a more distributed fashion. For example, the mobile devices or a specific application designed by the verifier organization and running on devices in the transportation service provider's vehicles may periodically provide lat/long, time, and other data to a server of the verifier, whether a determination has been made that any of the data is relevant or not. Alternatively or in addition, such data may be transmitted when a state of a vehicle changes, such as when it comes to a stop or shifts gears (under an assumption that pick ups and drop offs have to be accompanied by a stop and a shift into park)—such state change may occur using sensors in a vehicle that determine that the vehicle has entered park, or by identifying a lack of motion via GPS modules and related GPS data. Putting more power in the mobile clients, an application may run on the mobile devices and may have geo-fencing data pushed out to it (e.g., a verification server system may survey all of the pre-authorizations it has for a particular company, may generate geo-fences for each of them, and may push data for the geo-fences out to all the devices of each of the respective service providers). The client-side applications may then operate in the background on those devices and may themselves determine when they have entered or left a geo-fence, and may only then provide data to the verification system. In some embodiments, a user of such a device may be presented with a visual and/or audible warning before any such transmission is to occur, and they may be given several seconds to make a selection on their device to stop the transmission of the data, so that they may have very granular control over privacy.

At box 416, the verifier checks events received and generated from its receipt of location information from various vehicles against various prior authorizations it may have received and logged. Such checking (determining) may be continuous, such as when the verifier immediately generates a verification as soon as a service is provided. Alternatively, the checking may occur in response to specific events such as the submission of a claim by the service provider, which submission is then communicated directly or indirectly to the verifier, so that the verifier can confirm whether the services for which the claim has been made were actually performed.

At box 418, the verifier sends a confirmation that the event or events did occur (or an indication that its time-location data does not indicate that relevant events occurred). In this example, such confirmation is sent directly to the payer, though it may be provided to an agent of the payer or even in a communication that goes through the service provider (though perhaps is encrypted for a key held only by the payer or an agent of the payer).

At box 420, the payer receives the confirmation, and at box 419, the service provider may receive a copy of the confirmation. Such confirmation may be used by the payer at box 422 to determine whether the services were actually provided, and to then provide payment to the service provider, which payment is received at box 424.

The service provider may be copied so that it may know whether its services were confirmed or not, and may respond accordingly. For example, a lack of confirmation may have been the result, not of a failure to provide the service, but in an error in data entry, such as the provision of improper lat/long coordinates for the patient's home or the care center. Upon receiving the report and checking the report (box 419), the service provider may make a submission such as to indicate that the patient moved homes, and to insert new lat/long information for the patient's residence, thus triggering a new verification cycle by the verifier, and hopefully quick payment of the claim.

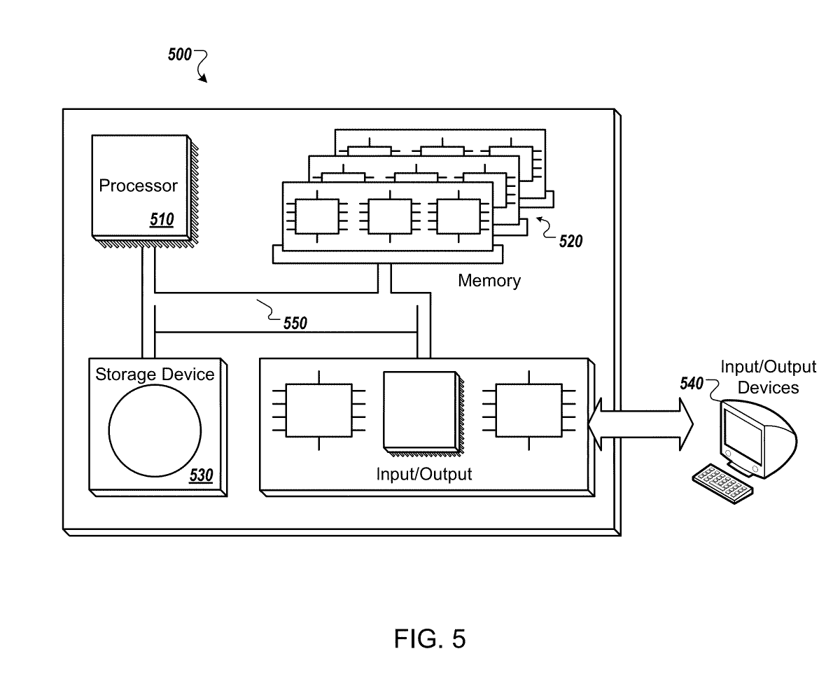

FIG. 5 shows an example of a computer system 500. The system 500 can be used for the operations described in association with any of the computer-implement methods described previously, according to one implementation. The system 500 is intended to include various forms of digital computers, such as laptops, desktops, workstations, personal digital assistants, servers, blade servers, mainframes, and other appropriate computers. The system 500 can also include mobile devices, such as personal digital assistants, cellular telephones, smartphones, and other similar computing devices. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. The processor may be designed using any of a number of architectures. For example, the processor 510 may be a CISC (Complex Instruction Set Computers) processor, a RISC (Reduced Instruction Set Computer) processor, or a MISC (Minimal Instruction Set Computer) processor.

In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving a data request from a device that corresponds to a healthcare service provider;
generating an identifier to represent a service performed by the service provider and transmitting the identifier to the service provider;
receiving a submission of the identifier from an organization associated with the service provider;
using the received identifier to look up information for confirming whether the service provider actually provided the service; and
transmitting information to the organization associated with the service provider, wherein the transmitted information indicates whether or not the service provider actually provided the service.

2. The computer-implemented method of claim 1, wherein the identifier is generated as part of a pre-authorization process by a payer for a plurality of transportation service events to be provided at future times.

3. The computer-implemented method of claim 1, wherein the identifier is a unique identifier relative to other identifiers currently in use for identifying other services performed by the service provider or other service providers, and encodes data about the services to be provided by the service provider.

4. The computer-implemented method of claim 1, further comprising receiving latitude/longitude data from global positioning system (GPS) systems in a plurality of vehicles, and using the longitude/latitude data to confirm whether the service provider actually provided the service.

5. A computer-implemented method performed by a location verification computer system, the method comprising:
receiving at the location verification computer system a pre-authorization for transportation services that includes a transaction identifier and data identifying (a) locations at which medical transportation services are to be provided for a patient, and (b) a transportation service provider to perform the services;
monitoring location reports from one or more vehicles determined to be operated by the transportation service provider to obtain location information that describes where the one or more vehicles have been located;
comparing the data generated from the location reports to the locations at which medical transportation services are to be provided for the patient;
determining, from the comparison, whether pre-authorized transportation services were provided for the patient; and
providing electronic data for an organization of a third party payer that indicates to the third party payer whether the pre-authorized transportation services were provided.

6. The computer-implemented method of claim 5, wherein:
the pre-authorized transportation services comprise a plurality of non-emergent trips for the patient; and
the system provides electronic data that indicates whether each of the plurality of trips for the patient occurred.

7. The computer-implemented method of claim 6, wherein a single identifier identifies all of the plurality of trips.

8. The computer-implemented method of claim 5, wherein determining whether pre-authorized transportation services were provided for the patient comprises using data from the pre-authorization to construct a geo-fence around a residence of the patient, and identifying that a vehicle of the transportation service provider entered the geo-fence.

9. The computer-implemented method of claim 8, further comprising determining that the vehicle of the transportation service provider entered a geo-fence established around a treatment center that was identified in the prer-authorization.

10. The computer-implemented method of claim 9, further comprising determining whether times when the vehicle entered the geo-fences correspond to a schedule for treatment established using the pre-authorization.

11. The computer-implemented method of claim 5, further comprising providing, with the electronic data for the organization of the third party payer, information that identifies a distance traveled by the vehicle of the transportation service provider in providing the transportation services.

12. The computer-implemented method of claim 11, wherein the location reports from the one or more vehicles are used to generate the information that identifies the distance traveled by the vehicle of the transportation service provider.

13. One or more tangible, machine-readable media having recorded thereon instructions that when executed by one or more computer processors, perform actions comprising:
receiving at the location verification computer system a pre-authorization for transportation services that includes a transaction identifier and data identifying (a) locations at which medical transportation services are to be provided for a patient, and (b) a transportation service provider to perform the services;
monitoring location reports from one or more vehicles determined to be operated by the transportation service provider to obtain location information that describes where the one or more vehicles have been located;
comparing the data generated from the location reports to the locations at which medical transportation services are to be provided for the patient;
determining, from the comparison, whether pre-authorized transportation services were provided for the patient; and
providing electronic data for an organization of a third party payer that indicates to the third party payer whether the pre-authorized transportation services were provided.

14. The one or more tangible, machine-readable media of claim 13, wherein:
the pre-authorized transportation services comprise a plurality of non-emergent trips for the patient; and
the system provides electronic data that indicates whether each of the plurality of trips for the patient occurred.

15. The one or more tangible, machine-readable media of claim 13, wherein a single identifier identifies all of the plurality of trips.

16. The one or more tangible, machine-readable media of claim 13, wherein determining whether pre-authorized transportation services were provided for the patient comprises using data from the pre-authorization to construct a geo-fence around a residence of the patient, and identifying that a vehicle of the transportation service provider entered the geo-fence.

17. The one or more tangible, machine-readable media of claim 16, wherein the actions further comprise determining that the vehicle of the transportation service provider entered a geo-fence established around a treatment center that was identified in the pre-authorization.

18. The one or more tangible, machine-readable media of claim 17, wherein the actions further comprise determining whether times when the vehicle entered the geo-fences correspond to a schedule for treatment established using the pre-authorization.

19. The one or more tangible, machine-readable media of claim 13, wherein the actions further comprise providing, with the electronic data for the organization of the third party payer, information that identifies a distance traveled by the vehicle of the transportation service provider in providing the transportation services.

20. The one or more tangible, machine-readable media of claim 19, wherein the location reports from the one or more vehicles are used to generate the information that identifies the distance traveled by the vehicle of the transportation service provider.
